(19) United States
(12) Patent Application Publication
(10) Pub. No.: US 2005/0128384 A1
(43) Pub. Date: Jun. 16, 2005

(54) Liquid crystal display

(75) Inventor: Jang-Kun Song, SEOUL (KR)

Correspondence Address: MCGUIREWOODS, LLP, 1750 TYSONS BLVD, SUITE 1800, MCLEAN, VA, 22102, US

(73) Assignee: SAMSUNG ELECTRONICS CO., LTD

(21) Appl. No.: 10/504,303

(22) PCT Filed: Jul. 26, 2002
(86) PCT No.: PCT/KR02/01415

(30) Foreign Application Priority Data
Feb. 19, 2002 (KR) 2002-8764

(51) Int. Cl. G02F 1/1333; G02F 1/1343

(52) U.S. Cl. 349/110; 349/139

(57) ABSTRACT

A lower substrate and an upper substrate are arranged opposite to each other with a cell gap therebetween. A black matrix and color filters are formed on the upper substrate, and metal signal lines (not shown) including gate signal lines and data signal lines and pixel electrodes (not shown) are formed on the lower substrate. A liquid crystal layer including twisted nematic liquid crystal (not shown) is arranged between the upper substrate and the lower substrate. An upper compensation film such as a scattering sheet and a refraction film is arranged on the upper substrate, and an upper polarization plate is arranged on the upper compensation film. A lower polarization plate is arranged on the lower substrate, and a lower compensation film such as a scattering sheet and a prism sheet is arranged on the lower polarization plate. A light guide plate of a backlight unit is arranged below the lower compensation film. Here, when it is assumed that a thickness of the upper substrate is L, a pixel pitch is p, and a width of the black matrix is w, and when the prism sheet is used as the lower compensation film, the relation (I) is satisfied. When the scattering sheet is used as the lower compensation film, the relation (II) is satisfied.

$$\begin{matrix}L < \frac{p + 2 w}{2 tan ( 17 ° )} & ( I ) \\ L < \frac{p + 2 w}{2 tan ( 25 ° )} & ( II )\end{matrix}$$

### BACKGROUND OF THE INVENTION

(a) Field of the Invention

The present invention relates to a liquid crystal display.

(b) Description of the Related Art

In general, a liquid crystal display (LCD) is a device for displaying pictures by controlling the transmittance of light depending on arrangement of liquid crystal molecules, which is changed by electric field produced across liquid crystal material interposed between an upper panel provided with a common electrode and color filters thereon and a lower panel provided with thin film transistors (TFTs) and pixel electrodes thereon by applying different electric potentials to tire pixel electrodes and the common electrode.

As well known in the art, the liquid crystal display has a main defect of its narrow viewing angle. A variety of methods which have been proposed for widening the viewing angle are described.

As one example, there is a method for controlling tit directions of liquid crystal molecules by orientating the liquid crystal molecules perpendicular to upper and lower panels and forming a cutout pattern or protrusions in pixel electrodes and a common electrode opposite to the pixel electrodes.

As another example, there is a method for rotating liquid crystal molecules on a plane parallel to a surface of a panel by horizontal electric field produced by two electrodes formed on the same panel.

As still another example, there is a method for widening a viewing angle by adding a scatter compensation film or a refraction compensation film to a conventional twisted nematic (TN) mode LCD.

Among these methods, the method for widening a viewing angle by adding the compensation film has a high availability in that the viewing angle is widened simply by adding a film to a conventional structure. However, this method has a problem of a reduced resolution due to a color mixture between adjacent pixels.

### SUMMARY OF THE INVENTION

In considerations of the above problem, it is a motivation of the present invention to improve a resolution of pictures in a liquid crystal display.

To achieve the object, in a liquid crystal display according to the present invention, a thickness of a glass substrate or a width of a black matrix is adjusted depending on a size of a pixel.

According to one aspect of the present invention, a liquid crystal display is provided, which includes a first insulation substrate, a plurality of first signal lines formed on an inner surface of the first substrate, a plurality of second signal lines formed on the inner surface of the first substrate and insulated from and intersecting the first signal lines, a plurality of pixel electrodes formed in pixel areas defined by intersections of the first signal lines and the second signal lines, a second insulation substrate having an inner surface opposite to the inner surface of the first substrate, a black matrix formed on the inner surface of the second substrate for partitioning the second substrate into the pixel areas, a common electrode formed on one of the first substrate and the second substrate for producing a driving electric field in cooperation with the pixel electrodes, and liquid crystal material injected between the first substrate and the second substrate, wherein the following condition is satisfied:

$$L < \frac{p + 2 w}{2 tan ( 17 ° )} ,$$

where L is a thickness of the second substrate, p is a pitch of the pixel areas, and w is a width of the black matrix.

Preferably, the liquid crystal display further includes a first polarization plate disposed on an outer surface of the first substrate, a first compensation film disposed on an outer surface of the first polarization plate, a light guide plate disposed on an outer surface of the first compensation film, a second compensation film attached to an outer surface of the second substrate and including a prism sheet, and a second polarization plate attached to an outer surface of the second compensation film.

Preferably, when a scattering sheet is used as the second compensation film in the liquid crystal display, the following condition is satisfied:

$$L < \frac{p + 2 w}{2 tan ( 25 ° )}$$

Preferably, the common electrode includes transparent conductive material on the inner surface of the substrate, and each of the pixel areas partitioned by the black matrix is provided with red, green and blue color filters.

According to another aspect of the present invention, a liquid crystal display is provided, which includes a first insulation substrate, a plurality of first signal lines formed on an inner surface of the first substrate, a plurality of second signal lines formed on the inner surface of the first substrate and insulated from and intersecting the first signal lines, a plurality of pixel electrodes formed in pixel areas defined by intersections of the first signal lines and the second signal lines, a second insulation substrate having an inner surface opposite to the inner surface of the first substrate, red, green and blue color filters formed for each of the pixel areas on the inner surface of the second substrate, black matrix formed on the inner surface of the second substrate for partitioning the red, green and blue color filters, a common electrode formed on one of the first substrate and the second substrate for producing a driving electric field in cooperation with the pixel electrodes, and liquid crystal material interposed between the first substrate and the second substrate, wherein the black matrix include a first portion for partitioning between sets of three consecutive red, green and blue color filters and a second portion for partitioning between color filters included in the set of color filters, the following condition is satisfied:

$$w > L tan ( 17 ° ) - \frac{p}{2} ,$$

where w is a width of the first portion of the black matrix, L is a thickness of the second substrate, and p is a pitch of the pixel areas.

Preferably, the liquid crystal display further includes a first polarization plate disposed on an outer surface of the first substrate, a first compensation film disposed on an outer surface of the first polarization plate, a light guide plate disposed on an outer surface of the first compensation film, a second compensation film attached to an outer surface of the second substrate and including a prism sheet, and a second polarization plate attached to an outer surface of the second compensation film.

Preferably, when a scattering sheet is used as the second compensation film in the liquid crystal display, the following condition is satisfied:

$$w > L tan ( 25 ° ) - \frac{p}{2} .$$

### BRIEF DESCRIPTION OF THE DRAWINGS

FIG. 1 is a schematic sectional view of a liquid crystal display according to a first embodiment of the present invention;

FIG. 2 is a detailed sectional view of a liquid crystal display according to the first embodiment of the present invention;

FIG. 3 shows a picture spread out by light scattering and refraction in the liquid crystal display;

FIG. 4 is a graph showing a beam profile for several kinds of backlight films;

FIG. 5 shows a light path experiencing refraction inside and outside a liquid crystal display panel;

FIG. 6 is a graph showing a relationship between an incident angle into a liquid crystal display and a refraction angle inside the liquid crystal display;

FIG. 7 is a conceptual view for calculating a width invaded into an adjacent pixel along with a path of light in a liquid crystal display;

FIG. 8 is a conceptual view showing visibility of a pixel depending on an invasion distance by scattering between adjacent pixels; and

FIG. 9 is a layout view of a color filter panel for a liquid crystal display according to a second embodiment of the present invention

### DETAILED DESCRIPTION OF THE PREFERRED EMBODIMENT

Preferred embodiments of the present invention will now be described in detail with reference to the accompanying drawings.

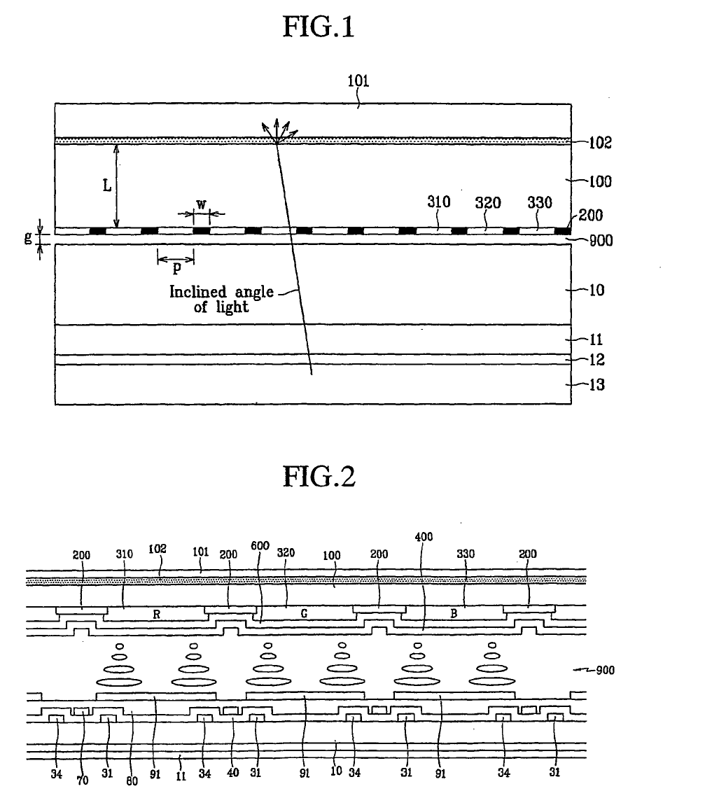

FIG. 1 is a schematic sectional view of a liquid crystal display according to a first embodiment of the present invention.

A lower substrate 10 and an upper substrate 100 are arranged opposite to each other with a cell gap g therebetween. A black matrix 200 and color filters 310, 320 and 330 are formed on the upper substrate 100, and metal signal lines (not shown) including gate signal lines and data signal lines and pixel electrodes (not shown) are formed on the lower substrate 10. A liquid crystal layer 900 including twisted nematic liquid crystal (not shown) is arranged between the upper substrate 100 and the lower substrate 10. An upper compensation film 102 such as a scattering sheet and a refraction film is arranged on the upper substrate 100, and an upper polarization plate 101 is arranged on the upper compensation film 102. A lower polarization plate 11 is arranged on the lower substrate 10, and a lower compensation film 12 such as a scattering sheet and a prism sheet is arranged on the lower polarization plate 11. A light guide plate 13 of a backlight unit is arranged below the lower compensation film 12. Here, it is common that the lower compensation film 12 is arranged together with the light guide plate 12 within the backlight unit.

Here, when it is assumed that a thickness of the upper substrate 100 is L, a pixel pitch is p, and a width of the black matrix is w, and when the prism sheet is used as the lower compensation film 12, the following relation is satisfied:

$$L < \frac{p + 2 w}{2 tan ( 17 ° )} . \qquad ( 1 )$$

Alternatively, when the scattering sheet other than the prism sheet is used as the lower compensation film 12, the following relation is satisfied:

$$L < \frac{p + 2 w}{2 tan ( 25 ° )} . \qquad ( 2 )$$

Then, a color mixture that colors of adjacent pixels cannot be distinguished can be prevented. The reason for obtaining such an effect will be described later. Now, a structure of the liquid crystal display according to the first embodiment of the present invention will be described in detail.

FIG. 2 is a detailed sectional view of a liquid crystal display according to the first embodiment of the present invention.

First, a lower TFT array panel will be described.

A plurality of gate lines (not shown) extending in a transverse direction are formed on an insulation substrate 10 such as transparent glass, and a plurality of storage capacitor lines 31 and 34 are formed on the same layer and by the same material as the gate lines. The gate lines have protrusion-typed gate electrodes (not shown). A gate insulation film 40 is formed on the gate signal lines and the storage capacitor lines 31 and 34. A semiconductor layer (not shown) made of amorphous silicon is formed on the gate insulation film 40 opposite the gate electrodes. A contact layer (not shown) made of amorphous silicon heavily doped with N-type impurity such as phosphorus (P) is formed on the semiconductor layer. A plurality of source electrodes (not shown) and a plurality of drain electrodes (not shown) are formed on both portions of the contact layer, respectively, and the source electrodes are connected to a plurality of data lines 70 formed on the gate insulation film 40 and extending in a longitudinal direction. A protection layer 80 having a plurality of contact holes (not shown) for exposing the drain electrodes is formed on the data lines 70, and a plurality of pixel electrodes 91 connected to the drain electrodes through the contact holes are formed on the protection layer 80. The pixel electrodes 91 made of transparent conductive material such as ITO (indium tin oxide) and IZO (indium zinc oxide).

Here, an electric potential to be applied to a common electrode of a color filter panel to be described later is typically applied to the storage capacitor lines 31 and 34.

Subsequently, an upper color filter panel will be described.

A plurality of pixel areas are defined by a black matrix 200 including double layers of Cr/Cr oxide and formed on the substrate 100 such as transparent glass. Red (R), green (G) and blue (B) color filters 310, 320 and 330 are formed in each of the pixel areas. The color filters 310, 320 and 330 are coated with an overcoat film 600 for protecting the color filters 310, 320 and 330, and a common electrode 400 made of a transparent conductor such as ITO is formed on the overcoat film 600. The common electrode 400 produces an electric field for changing an orientation of liquid crystal in cooperation with the pixel electrodes 91.

On the other hand, the black matrix 200 can be formed by organic insulation material added by black pigment, instead of being formed by metal material such as Cr.

The thin film transistor array panel and the color filter panel as described above are aligned and assembled, the liquid crystal material 900 is injected between the panel assembly such that liquid crystal molecules in the liquid crystal material 900 are twisted-oriented. Two polarization plates 11 and 101 are disposed outside the two substrates 10 and 100 such that their polarization axes are aligned parallel or perpendicular to each other. Finally, when a compensation film 12 such as a scattering sheet is provided between an upper polarization plate 11 and the upper substrate 10 in order to realize a wide viewing angle, the liquid crystal display according to the first embodiment is completed.

The effect of the present invention will be described below.

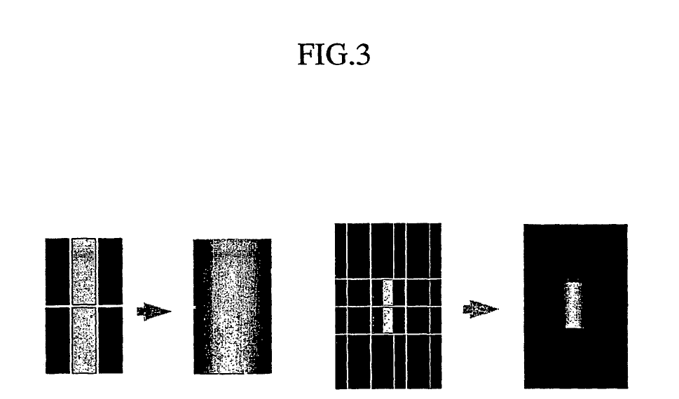

First, the reason of a color mixture between adjacent pixels will be described with reference to FIGS. 1 and 3.

FIG. 3 shows a picture spread out by light scattering and refraction in a liquid crystal display.

In a liquid crystal display having a compensation film for realizing the wide viewing angle by using the compensation film, visibility becomes similar in all directions by scattering light passing through the liquid crystal layer 900 in the compensation film 102 to all directions. At this time, the light passing through the color filters 310, 320 and 330 has to pass through the upper substrate 100 before arriving at the scattering sheet 102. However, in the case that the light is inclined at a certain angle, the light deviates from its own pixel area, i.e., is positioned on an adjacent pixel region when arriving at the scattering sheet 102. Thus, as shown in FIG. 3, the color mixture between adjacent pixels appears.

Now, an angle at which the light emitted from a backlight passes through the liquid crystal panel will be considered.

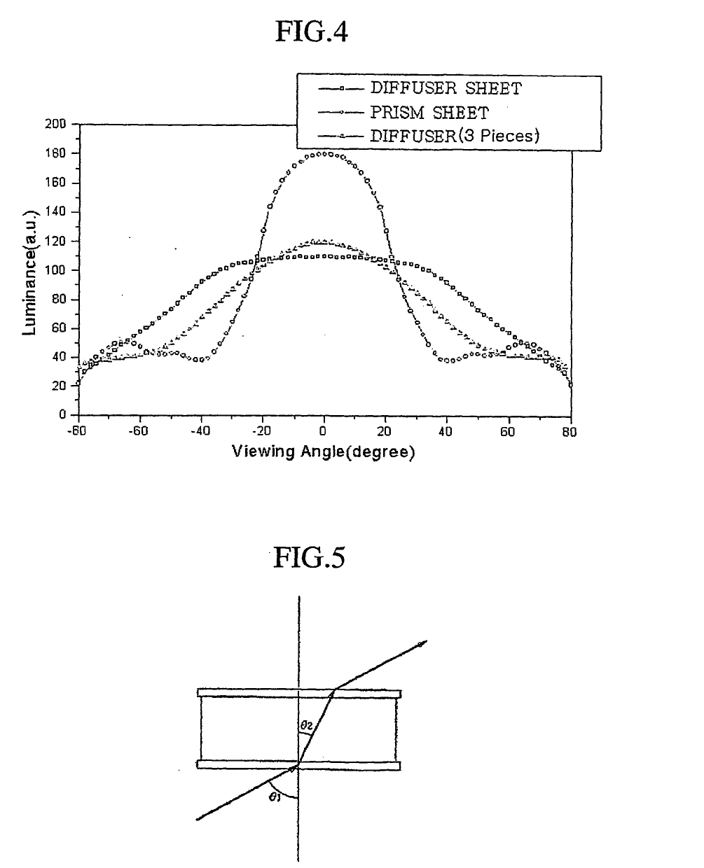

FIG. 4 is a graph showing a beam profile for several kinds of backlight film, and FIG. 5 shows a light path of refraction inside and outside a liquid crystal display panel.

Referring to FIG. 4, when the light emitted from the backlight is incident inside the liquid crystal panel through the prism panel, the light is concentrated on a path between 0° and 25°, but 0° and 40° in the case of one piece of scattering film, in an incident angle. In the case of three pieces of scattering film, the light is more concentrated on a center portion compared with one piece of scattering film. However, it can be typically considered that the light lying between 0° and 40° in the incident angle is effective. By the way, referring to FIG. 5, since the light is refracted during an incidence inside into the panel, an incident angle into the panel is different from a traveling angle inside the panel.

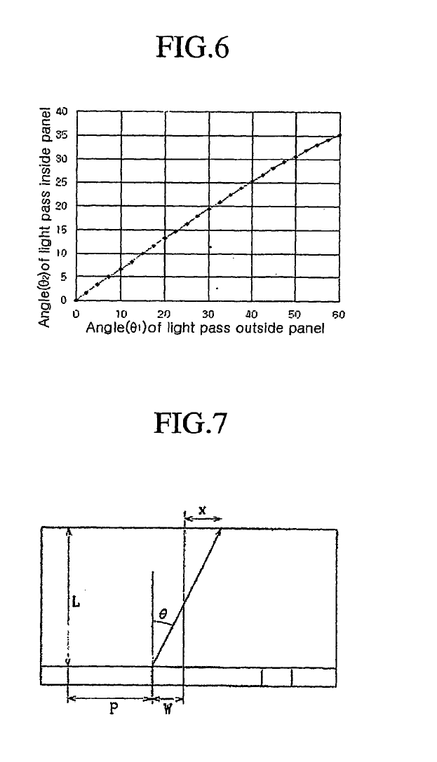

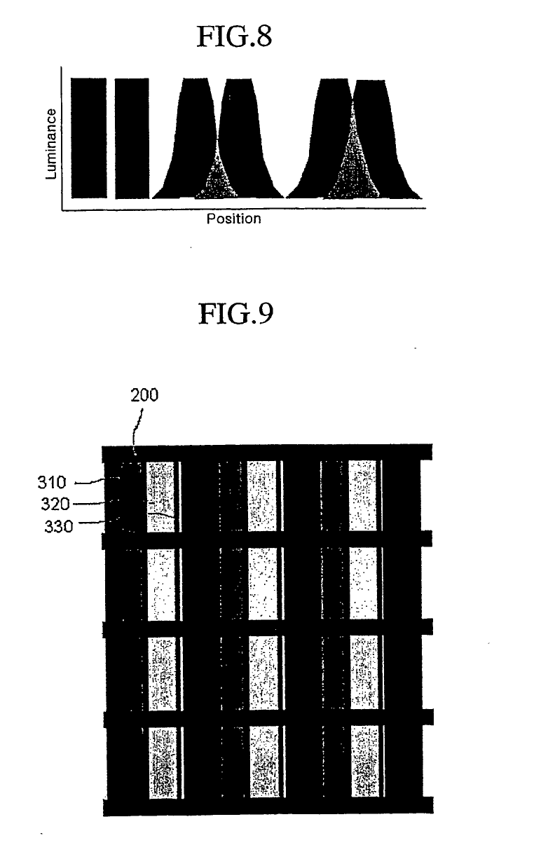

FIG. 6 is a graph showing a relationship between an incident angle into a liquid crystal display and a refraction angle inside the liquid crystal display.

Referring to FIG. 6, a range of 0° to 25° as a main path of light in the case of the prism sheet becomes a range of 0° to 17° inside the panel. Also, a range of 0° to 40° as a main path of light in the case of the scattering film becomes a range of 0° to 0° inside the panel. The liquid crystal display using the prism sheet is mainly used for notebook computers, while the liquid crystal display using the scattering film is mainly used for monitors or TVs.

Now, a calculation on a distance invading into an adjacent pixel will be explained.

FIG. 7 is a conceptual view for calculating a width invading into an adjacent pixel along with a path of light in a liquid crystal display.

If a distance invading into an adjacent pixel is set to x, x is calculated from the following relation:
x=L tan θ−w (3)

Here, in order to avoid a color mixture between pixels, x has to become 0, in other words, the light should not invade into the adjacent pixel. In order that a viewer can distinguish two adjacent pixels even though the color mixture between the adjacent pixels is partly presented, x representing an invasion width does not exceed a half of a width p of a pixel. That is, the following relation should be satisfied:

$$x = L tan θ - w < \frac{p}{2} . \qquad ( 4 )$$

Rearranging Relation 4 in terms of L, the following relation is obtained:

$$L \leq \frac{p + 2 w}{2 tan θ} . \qquad ( 5 )$$

As described above, since the light path is concentrated on between 0° and 17° in the incident angle when the prism sheet is used as the lower compensation film, and the path of light is concentrated on between 0° and 25° in the incident angle when the scattering sheet is used as the lower compensation film, conditions for distinguishing two adjacent pixels are Relations 1 and 2, respectively.

Then, a size of pixel, depending on a thickness of actually applicable glass substrate; required to distinguish two adjacent pixels each other will be calculated. In Relation 5, the width w of the black matrix becomes about 1/10 of the width of the pixel. That is,

$$w ≃ \frac{p}{10} .$$

Putting this relation into Relation 5, the following relation is obtained:

$$L < \frac{p + \frac{p}{5}}{2 tan θ} = \frac{3 p}{5 tan θ} . \qquad ( 6 )$$

In the case of glass substrates with thicknesses of 700 μm 500 μm and 300 μm, when minima pixel pitches required to distinguish two adjacent pixels in the case of the prism sheet and the scattering sheet are calculated by using Relation 6, the following table is obtained.

TABLE 1

Pixel pitch

| Substrate thickness | Prism sheet | Scattering sheet |
|---|---|---|
| 700 μm | ≧350 μm | ≧540 μm |
| 500 μm | ≧250 μm | ≧380 μm |
| 300 μm | ≧150 μm | ≧230 μm |

Although pixel pitches smaller than the pixel pitches listed in Table 1 can be employed depending on a use or grade of the liquid crystal display, it is considered that liquid crystal displays with high visibility may not be produced by such smaller pixel pitches.

FIG. 9 is a layout of a color filter panel for a liquid crystal display according to a second embodiment of the present invention.

The second embodiment is similar in its structure to the first embodiment except for an arrangement interval of the black matrix and color filters. In the second embodiment, partitions of the black matrix partitioning sets of three red, green and blue pixels grouped are wider than other portions partitioning red, green and blue pixels in one set of pixel). When the prism sheet is used as the lower compensation film 12, the width of the partitions of the black matrix between the sets of pixels satisfies the following relation:

$$w > L tan ( {17}^{°} ) - \frac{p}{2} . \qquad ( 7 )$$

When the scattering sheet is used as the lower compensation film 12, the width of the partitions of the black matrix between the sets of pixels satisfies the following relation:

$$w > L tan ( {25}^{°} ) - \frac{p}{2} . \qquad ( 8 )$$

For example, in the case that a pixel pitch is fixed to 300 μm and a thickness of the upper substrate is 700 μm, 500 μm and 300 μm, respectively, when minimal widths of the black matrix required to distinguish two adjacent pixels in the case that the prism sheet and the scattering sheet are used as the lower compensation film are calculated, the following table is obtained.

TABLE 2

Black matrix width (Pixel pitch = 300 μm)

| Substrate thickness | Prism sheet | Scattering sheet |
|---|---|---|
| 700 μm | ≧63 μm | ≧174 μm |
| 500 μm | ≧28.5 μm | ≧81 μm |
| 300 μm | Not limited | Not limited |

When the black matrix is formed to meet with Table 2, two adjacent sets of pixels can be distinguished each other. Here, portions of the black matrix to satisfy the conditions on width listed in Table 2 is only the portions between the sets of pixels including three red, green and blue color filters, while portions of the black matrix partitioning the red, green and blue color pixels in one set are not required to satisfy the conditions on width listed in Table 2. This is because the color mixture among the red, green and blue color pixels representing one dot of a picture is acceptable.

Although the structure where the pixels electrodes and the common electrode are formed on the lower substrate and the upper substrate, respectively, has been described by way of examples, the present invention is applicable to a liquid crystal display where the pixels electrode and the common electrode are formed on the same substrate for producing an electric field parallel to the substrate.

As described above, by removing the common electrode above the data line and forming the openings for the data line, load of the signal line is reduced, a variation of liquid crystal capacitance across the signal line is reduced, a leakage of light due to a side crosstalk is reduced, and an aperture ratio is increased. When the load of signal line is reduced, a limitation on a resolution and a size of structure where the data line is formed by a single chrome film can be overcome, which results in an implementation of a wider liquid crystal display with higher resolution When the variation of liquid crystal capacitance across the signal line is reduced, because lengthwise crosstalk first appearing when a charge ratio is low is overcome, a limitation on the charge ratio can be overcome. In addition, the reduction of the leakage of light due to the side crosstalk and the increase of the aperture ratio can result in a liquid crystal display with good quality of a picture.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A liquid crystal display comprising:
a first insulation substrate;
a plurality of first signal lines formed on an inner surface of the first substrate;
a plurality of second signal lines formed on the inner surface of the first substrate and insulated from and intersecting the first signal lines;
a plurality of pixel electrodes in pixel areas defined by intersections of the first signal lines and the second signal lines;
a second insulation substrate having an inner surface opposite to the inner surface of the first substrate;
a black matrix formed on the inner surface of the second substrate for partitioning the second substrate into the pixel areas;
a common electrode formed on one of the first substrate and the second substrate for producing a driving electric field in cooperation with the pixel electrodes; and
liquid crystal material injected between the first substrate and the second substrate,
wherein the following condition is satisfied:
$$L < \frac{p + 2 w}{2 tan ( {17}^{°} )} ,$$
where L is a thickness of the second substrate, p is a pitch of the pixel areas, and w is a width of the black matrix.

2. The liquid crystal display of claim 1, further comprising:
a first polarization plate disposed on art outer surface of the first substrate; a first compensation film disposed on an outer surface of the first polarization plate;
a light guide plate disposed on an outer surface of the first compensation film;
a second compensation film attached to an outer surface of the second substrate and including a prism sheet; and
a second polarization plate attached to an outer surface of the second compensation film.

3. The liquid crystal display of claim 1, wherein the following condition is satisfied:
$$L < \frac{p + 2 w}{2 tan ( {25}^{°} )} .$$

4. The liquid crystal display of claim 3, further comprising:
a first polarization plate disposed on an outer surface of the first substrate;
a first compensation film disposed on an outer surface of the first polarization plate;
a light guide plate disposed on an outer surface of the first compensation film;
a second compensation film attached to an outer surface of the second substrate and including a scattering sheet; and
a second polarization plate attached to an outer surface of the second compensation film.

5. The liquid crystal display of claim 1, wherein the common electrode includes transparent conductive material on the inner surface of the substrate.

6. The liquid crystal display of claim 1, further comprising red, green and blue color filters formed in each of the pixel areas partitioned by the black matrix.

7. The liquid crystal display of claim 6, wherein the black matrix include a first portion for partitioning between sets of three consecutive red, green and blue color filters and a second portion for partitioning between color filters included in the set of color filters, a width of the first portion being wider than a width of the second portion.

8. A liquid crystal display comprising:
a first insulation substrate;
a plurality of first signal lines formed on an inner surface of the first substrate;
a plurality of second signal lines formed on the inner surface of the first substrate and insulated from and intersecting the first signal lines;
a plurality of pixel electrodes formed in each of pixel areas defined by intersections of the first signal lines and the second signal lines;
a second insulation substrate having an inner surface opposite to the inner surface of the first substrate;
red, green and blue color filters in the pixel areas on the inner surface of the second substrate;
a black matrix formed on the inner surface of the second substrate for partitioning the red, green and blue color filters;
a common electrode formed on one of the first substrate and the second substrate for producing a driving electric field in cooperation with the pixel electrodes; and
liquid crystal material interposed between the first substrate and the second substrate,
wherein the black matrix include a first portion for partitioning between sets of three consecutive red, green and blue color filters and a second portion for partitioning between color filters included in the set of color filters, the following condition is satisfied:
$$w > L tan ( {17}^{°} ) - \frac{p}{2}$$
where w is a width of the first portion of the black matrix, L is a thickness of the second substrate, and p is a pitch of the pixel areas.

9. The liquid crystal display of claim 8, further comprising:
a first polarization plate disposed on an outer surface of the first substrate;
a first compensation film disposed on an outer surface of the first polarization plate;
a light guide plate disposed on an outer surface of the first compensation film;
a second compensation film attached to an outer surface of the second substrate and including a prism sheet; and
a second polarization plate attached to an outer surface of the second compensation film.

10. The liquid crystal display of claim 8, wherein the following condition is satisfied:
$$w > L tan ( {25}^{°} ) - \frac{p}{2} .$$

11. The liquid crystal display of claim 10, further comprising:
a first polarization plate disposed on an outer surface of the first substrate;
a first compensation film disposed on an outer surface of the first polarization plate;
a light guide plate disposed on an outer surface of the first compensation film;
a second compensation film attached to an outer surface of the second substrate and including a scattering sheet; and
a second polarization plate attached to an outer surface of the second compensation film.

12. The liquid crystal display of claim 2, wherein the common electrode includes transparent conductive material on the inner surface of the substrate.

13. The liquid crystal display of claim 2, further comprising red, green and blue color filters formed in each of the pixel areas partitioned by the black matrix.

14. The liquid crystal display of claim 13, wherein the black matrix include a first portion for partitioning between sets of three consecutive red, green and blue color filters and a second portion for partitioning between color filters included in the set of color filters, a width of the first portion being wider than a width of the second portion.

15. The liquid crystal, display of claim 3, wherein the common electrode includes transparent conductive material on the inner surface of the substrate.

16. The liquid crystal display of claim 3, further comprising red, green and blue color filters formed in each of the pixel areas partitioned by the black matrix.

17. The liquid crystal display of claim 16, wherein the black matrix include a first portion for partitioning between sets of three consecutive red, green and blue color filters and a second portion for partitioning between color filters included in the set of color filters, a width of the first portion being wider than a width of the second portion.

18. The liquid crystal display of claim 4, wherein the common electrode includes transparent conductive material on the inner surface of the substrate.

19. The liquid crystal display of claim 4, further comprising red, green and blue color filters formed in each of the pixel areas partitioned by the black matrix.

20. The liquid crystal display of claim 19, wherein the black matrix include a first portion for partitioning between sets of three consecutive red, green and blue color filters and a second portion for partitioning between color filters included in the set of color filters, a width of the first portion being wider than a width of the second portion.
